(19) United States
(12) Patent Application Publication
(10) Pub. No.: US 2018/0348741 A1
(43) Pub. Date: Dec. 6, 2018

(54) MANUFACTURING LINE MONITORING DEVICE, MANUFACTURING LINE MONITORING PROGRAM, AND MANUFACTURING LINE MONITORING METHOD

(71) Applicants: KABUSHIKI KAISHA TOSHIBA, Minato-ku (JP); TOSHIBA SOLUTIONS CORPORATION, Kawasaki-shi (JP)

(72) Inventors: Katsumi MAENOSONO, Kawasak-shi (JP); Noriyuki ARAI, Kawasak-shi (JP); Satoshi MAESUGI, Kawasak-shi (JP); Yukiteru NOZAWA, Kawasak-shi (JP); Yuusuke NARASAKO, Kawasak-shi (JP); Hisanori HATA, Kawasak-shi (JP)

(73) Assignees: KABUSHIKI KAISHA TOSHIBA, Minato-ku (JP); TOSHIBA SOLUTIONS CORPORATION, Kawasaki-shi (JP)

(21) Appl. No.: 15/511,508

(22) PCT Filed: Sep. 29, 2014
(86) PCT No.: PCT/JP2014/075899

§ 371 Date: Aug. 10, 2018

(51) Int. Cl. G05B 19/418; G06Q 50/04

(52) U.S. Cl. CPC G05B 19/4184; G05B 2219/14043; G05B 2219/14006; G06Q 50/04

(57) ABSTRACT

A manufacturing line includes a receiving unit that receives sensor data indicative of a measured value by a sensor provided near a manufacturing device constituting a manufacturing line, a sensor determining unit that determines whether the measured value indicated by the sensor data exceeds a first sensor threshold value indicative of a predetermined range, and a notifying unit that sends a sensor abnormality notification, which notifies a user of the client terminal that the manufacturing device malfunctions, in a case where the sensor determining unit determines that the measured value exceeds the first sensor threshold value.

### CROSS REFERENCE TO RELATED APPLICATION

This application is based upon and claims the benefit of propriety from PCT Application No. PCT/JP2014/75899, filed Sep. 29, 2014 the entire contents of which are incorporated herein by reference.

### FIELD

Embodiments described herein relate generally to a technique for monitoring a manufacturing line.

### BACKGROUND

Conventionally, an overhaul of a manufacturing line has been periodically conducted for preventive maintenance in order to prevent the manufacturing line from failing in operation. In this maintenance, for example, a driving motor in the manufacturing line includes a thermometer and an ammeter. An operator at the site visually inspects the thermometer and the ammeter so as to check whether there is any irregularity in the manufacturing line. In a case where any failure occurs, the manufacturing line is stopped so as to repair or replace the failed component.

### BRIEF DESCRIPTION OF DRAWINGS

FIG. 1 is a schematic diagram illustrating an overall configuration of a manufacturing line monitoring system of an embodiment.

FIG. 2 is a block diagram illustrating a hardware configuration of a gateway terminal, a server, and a client terminal.

FIG. 3 is a block diagram illustrating a functional configuration of the gateway terminal and the server.

FIG. 4 is a flowchart illustrating an operation of notification processing.

### DETAILED DESCRIPTION

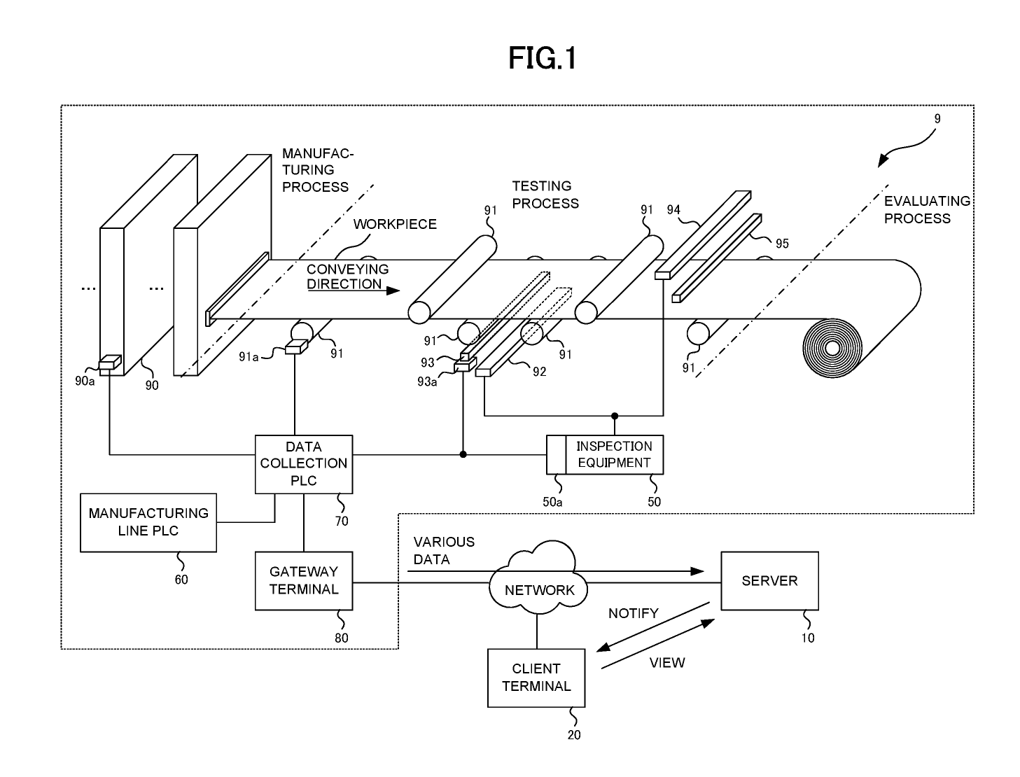

The embodiments will be explained by reference to the accompanying drawings. First, referring to FIG. 1, an overall configuration of a manufacturing line monitoring system of the embodiment will be discussed. FIG. 1 is the manufacturing line monitoring system of the embodiment.

As shown in FIG. 1, the manufacturing line monitoring system of the embodiment includes a manufacturing line 9, a inspection equipment 50, a manufacturing line PLC (Programmable Logic Controller) 60, a data collection PLC 70, and a gateway terminal 80, respectively installed at the manufacturing line floor, and also includes a server 10, and a client terminal 20, respectively installed at remote locations. In this regard, the server 10 and the client terminal 20 are installed at locations different from each other.

The manufacturing line 9 in this embodiment includes a plurality of manufacturing devices, and manufactures films with these devices. The manufacturing process of the manufacturing line 9 includes at least a heater 90 for melting a film material. The testing process of the manufacturing line 9 includes a plurality of conveying rolls 91 that convey, as workpieces, films continuously manufactured in the manufacturing process, a camera 92 that captures a back surface of a workpiece, a lighting 93 that illuminates an imaging range of the camera 92, a camera 94 that captures a front surface of the workpiece, and a lighting 95 that illuminates an imaging range of the camera 94. The captured images of the cameras 92 and 94 are used by a inspection equipment 50 for testing workpieces, and defect evaluation is executed in an evaluating process based on a test result of the inspection equipment 50. In the defect evaluation, workpieces are determined to be good or bad at predetermined intervals in the conveying direction. Further, a temperature sensor 90a is provided near the heater 90 to measure a temperature of the heater 90, a vibration sensor 91a is provided near a driving unit of the conveying roll 91 to measure vibration of the conveying roll 91, and an illuminance sensor 93a is provided near the lighting 93 to measure illuminance of the lighting 93. The temperature sensor 90a outputs a temperature of the heater 90, the vibration sensor 91a outputs acceleration, speed, and displacement as vibration of the conveying roll 91, and the illuminance sensor 93a outputs illuminance of the lighting 93.

The inspection equipment 50 inspects the workpieces to detect a defect based on the captured images of the cameras 92 and 94. The defects to be detected include a pinhole, a black spot, a fish eye (FE), and a scratch, for example. For each workpiece, the inspection equipment 50 outputs a type of a defect and its number or size to the data collection PLC 70 as inspection data. The inspection equipment 50 is a personal computer (PC) installed with a program for performing tests, and a temperature sensor 50a for measuring a temperature is provided near a heat exhaust part of the casing of the inspection equipment 50. The temperature sensor 50a outputs a temperature of the inspection equipment 50.

The manufacturing line PLC (Programmable Logic Controller) 60 is connected to the equipment of the manufacturing line 9, receives signals indicating an operating state, and outputs signal values to the data collection PLC 70 as manufacturing line data. The signals indicating the operating state include, for example, a fault signal indicating that the manufacturing line 9 fails, an inverter control output of a driving part, a conveying line speed indicating a conveying speed of a workpiece, and an operational frequency of the manufacturing line 9.

The data collection PLC 70 obtains inspection data from the inspection equipment 50, manufacturing line data from the manufacturing line PLC 60, and values from sensors 90a to 93a and 50a as sensor data, and outputs the obtained inspection data, manufacturing line data, and sensor data to the gateway terminal 80.

The gateway terminal 80 receives the inspection data, the manufacturing line data, and the sensor data from the data collection PLC 70, and sends the received data to the server 10 in a remote area via a network.

The server 10 stores the inspection data, the manufacturing line data, and the sensor data sent from the gateway terminal 80, and makes the data viewable on the client terminal 20. The server 10 determines the data based on an indication from the client terminal 20, and notifies the client terminal 20 of the determining result as necessary.

The client terminal 20 is a personal computer that is installed at a place different from places where the manufacturing line 9 and the server 10 are respectively installed, and used by a maintainer of the manufacturing line 9. Various kinds of data stored in the server 10 are viewable on the client terminal 20 with a browser. Further, the client terminal 20 gives instructions regarding the determination on the data determined by the server 10, and receives a notification based on the determination.

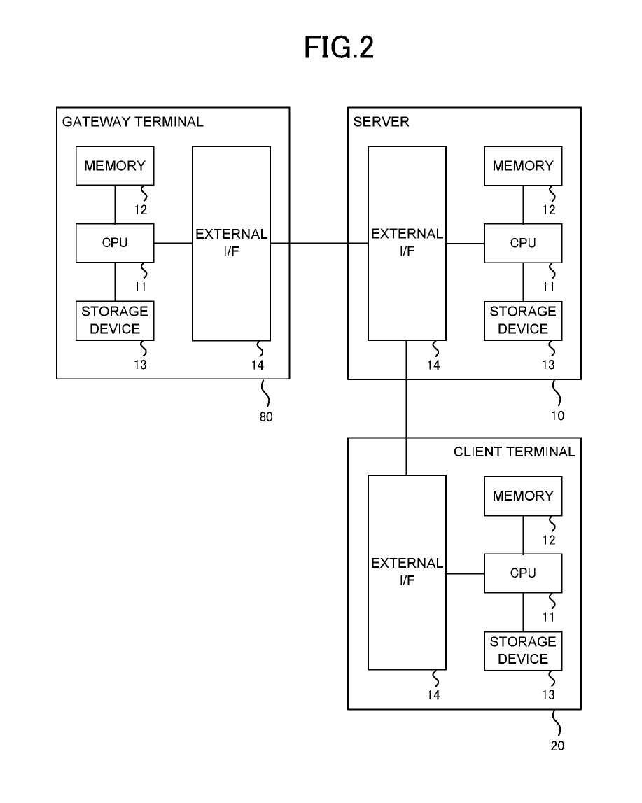

Next, it explains architecture about configuration of the gateway terminal, the server, and the client terminal. FIG. 2 is a block diagram illustrating the hardware configuration of the gateway terminal, the server, and the client terminal.

As shown in FIG. 2, each of the gateway terminal 80, the server 10, and the client terminal 20 include a central processing unit (CPU) 11, a memory 12 that is a main storage device, a non-volatile storage device 13, and an external I/F (interface) 14 for communicating with other devices. The respective external I/Fs 14 of the gateway terminal 80, the server 10, and the client terminal 20 are connected to a network. The gateway terminal 80 and the client terminal 20 are connected to the server 10 such that data can be transmitted and received.

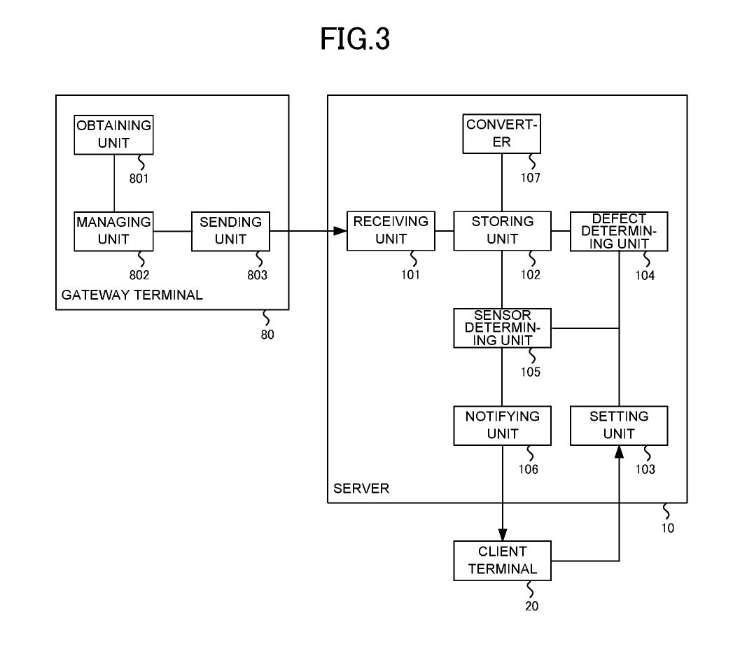

Next, it explains function about a functional configuration of the gateway terminal and the server. FIG. 3 is a block diagram illustrating the functional configuration of the gateway terminal and the server.

As shown in FIG. 3, the gateway terminal 80 functionally includes an obtaining unit 801, a managing unit 802, and a sending unit 803. These functions are implemented in the gateway terminal 80 when a program stored in the storage device 13 is loaded to the memory 12 and the CPU 11 executes arithmetic operations of the loaded program.

The obtaining unit 801 obtains the inspection data, the manufacturing line data, and the sensor data. The managing unit 802 associates various kinds of data obtained by the obtaining unit 801 with obtaining dates and times of the data. The sending unit 803 sends the data associated with the dates and times by the managing unit 802 to the server 10 via a network. The sending unit 803 sends the data in a cycle equal to or longer than a cycle in which the obtaining unit 801 obtains data. The sending unit 803 collectively sends the data obtained per this cycle to the server 10.

The server 10 functionally includes a receiving unit 101, a storing unit 102, a setting unit 103, a defect determining unit 104, a sensor determining unit 105, a notifying unit 106, and a converter 107. These functions are implemented in the server 10 when, similarly to the gateway terminal 80, a manufacturing line monitoring program stored in the storage device 13 is loaded to the memory 12 and the CPU 11 executes arithmetic operations of the loaded program.

The receiving unit 101 receives the data sent from the sending unit 803 of the gateway terminal 80. The storing unit 102 associates the various kinds of data received by the receiving unit 101 with one another, and stores the data in the storage device 13 of the server 10 in time series. The setting unit 103 associates a defect type of a workpiece with a specific sensor related to the defect type based on an indication from the client terminal 20. Further, the setting unit 103 sets a first defect threshold value described later to a defect determining unit 104, and a first sensor threshold value described later to a sensor determining unit 105. Here, the first defect threshold value is set as a predetermined value, and the first sensor threshold value is set as a value indicating one of upper limit and lower limit, upper limit only, and lower limit only. In the following, these values are collectively called as a setting range. The defect determining unit 104 determines the inspection data based on the first defect threshold value set by the setting unit 103 and the second defect threshold value, which is a value smaller than the first defect threshold value by a predetermined amount. The sensor determining unit 105 determines the sensor data based on the first sensor threshold value set by the setting unit 103 and a second sensor threshold value that is different from the upper limit or the lower limit of the first sensor threshold value by a predetermined amount in the setting range. The notifying unit 106 notifies the client terminal 20 of an abnormality or a warning of a workpiece or an object measured by the sensor based on the determination by the sensor determining unit 105 or the determination by the defect determining unit 104 and the sensor determining unit 105. The converter 107 converts the data stored in the storing unit 102 into a format viewable by the client terminal 20 so that the maintainer can easily recognize the situation of the manufacturing line 9.

The storing unit 102 associates various kinds of data with one another such that data having the longest output cycle is associated with another data that is contained in such a cycle at the time. For example, in a case where the inspection equipment 50 outputs data every one second, the manufacturing line PLC60 outputs data every 0.2 seconds, and the sensors output data every 0.1 second, one item of the inspection data is associated with five items of the manufacturing line data and ten items of the sensor data.

Regarding notifications by the notifying unit 106, an abnormality notification about a workpiece indicates that the number or sizes of defects on the workpiece already exceed an allowable range, and a warning notification about a workpiece indicates a possibility that the number or sizes of defects on the workpiece will likely exceed the allowable range. Further, an abnormality notification about a measured object indicates that the object measured by a sensor no longer operates properly, and a warning notification about a measured object indicates a possibility that the object measured by a sensor will not operate properly. Specifically, these notifications are provided by the notifying unit 106 by sending an e-mail to the client terminal 20, and the maintainer understands a type and a specific situation of the notification by the title or the text of the e-mail.

The data conversion by the converter 107 includes graphing and converting various kinds of data in a HTML format. The inspection data, the manufacturing line data, and the sensor data are graphed to generate a graph representing data values in a vertical axis and times in a horizontal axis. Preferably, the graph uses the same time scale for all items of the data and has the values of all items of the data obtained at the same timing so that the maintainer can easily recognize the relevance between the inspection data, the manufacturing line data, and the sensor data. Further, by converting the data in a HTML format, it is possible to view graphs of various data in a browser of the client terminal 20 without using a specific application for viewing the graphs of the data.

Further, by HTML conversion, the converter 107 provides an interface for receiving an indication from the client terminal 20. This interface provides, as setting items, a text box in which a value as a first defect threshold value can be entered, a radio box that enables to select one of “lower limit and upper limit”, “lower limit only”, and “upper limit only” as a setting method of the first sensor threshold value, one or two text boxes that are displayed according to the selection of the radio box and enable to enter a value as a first sensor threshold value, and a checkbox that is prepared for each defect type in the inspection data and indicates at least one sensor type associated with one defect type. Similarly to the checkbox indicating the sensor type, an additional checkbox indicating a type of an operating state may also be provided, where at least one operating state type is associated with one defect type.

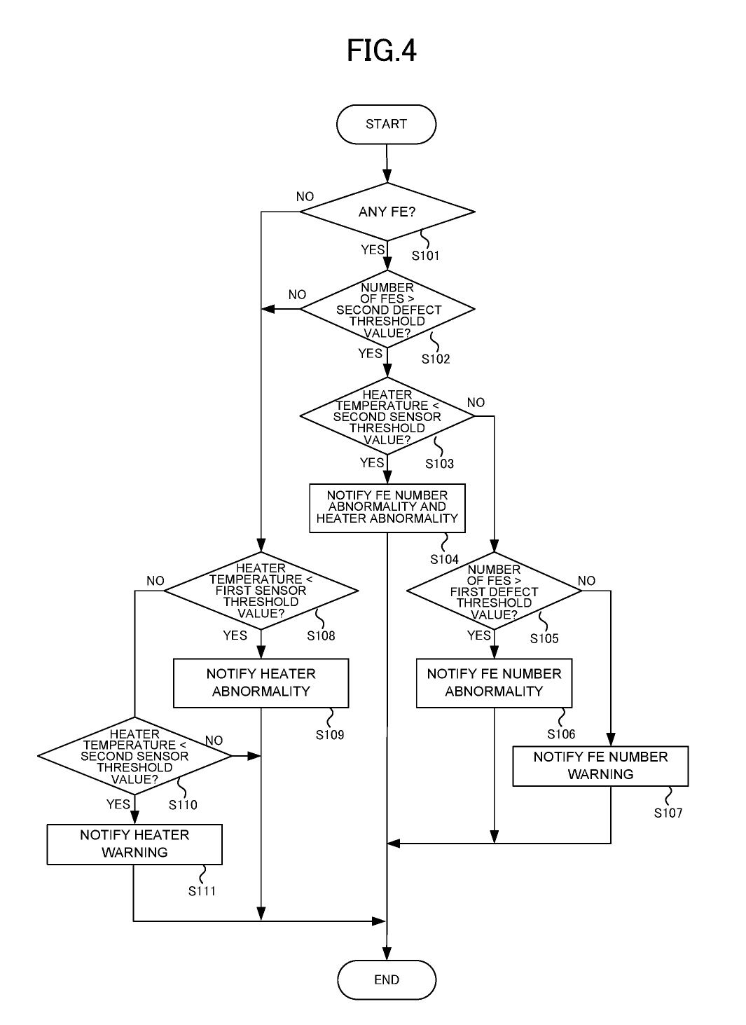

Next, operations of notification processing for notifying the client terminal based on a defect of a workpiece and a measured value of a sensor will be discussed. FIG. 4 is a flow chart showing operations of the notification processing. In this flow chart, assume a case where the setting unit previously associates an FE, which is one of defect types, with a temperature sensor, which is one of the sensor types and provided near the heater, the first defect threshold value is set to the number of FEs, and the first sensor threshold value having only the lower limit for the temperature sensor near the heater is set. Further, the notification processing is described as being performed each time the receiving unit receives an item of the data.

As shown in FIG. 4, the defect determining unit 104 determines whether an FE is found in a workpiece by referring to the inspection data (S101).

If there is an FE (S101:YES), the defect determining unit 104 determines whether the number of FEs is greater than the second defect threshold value that is smaller than the first defect threshold value by a predetermined amount (S102).

If the number of FEs is greater than the second defect threshold value (S102:YES), the sensor determining unit 105 determines whether the heater temperature measured by the temperature sensor 90a is smaller than the second sensor threshold value (S103). Here, the second sensor threshold value is different from the first sensor threshold value by a predetermined amount within a range, and is greater than the first sensor threshold value by a predetermined amount in this embodiment where only the lower limit is set.

If the heater temperature is smaller than the second sensor threshold value (S103:YES), the notifying unit 106 notifies the client terminal 20 of FE number abnormality as an abnormality notification about a workpiece, and heater abnormality as an abnormality notification about the measured object (S104).

If the heater temperature is equal to or more than the second sensor threshold value (S103:NO), the defect determining unit 104 determines whether the number of FEs is greater than the first defect threshold value (S105).

If the number of FEs is greater than the first defect threshold value (S105:YES), the notifying unit 106 notifies the client terminal 20 of the FE number abnormality (S106).

If the number of FEs is equal to or less than the first defect threshold value (S105:NO), the notifying unit 106 notifies the client terminal 20 of a FE number warning as a warning notification about the workpiece (S107).

In step S102, if the number of FEs is equal to or less than the second defect threshold value (S102:NO), the sensor determining unit 105 determines whether the heater temperature is smaller than the first sensor threshold value (S108).

If the heater temperature is smaller than the first sensor threshold value (S108:YES), the notifying unit 106 notifies the client terminal 20 of the heater abnormality (S109).

If the heater temperature is equal to or more than the first sensor threshold value (S108:NO), the sensor determining unit 105 determines whether the heater temperature is smaller than the second sensor threshold value (S110).

If the heater temperature is smaller than the second sensor threshold value (S110:YES), the notifying unit 106 notifies the client terminal 20 of a heater warning as a warning notification about the measured object (S111).

If the heater temperature is equal to or more than the second sensor threshold value (S110:NO), the sensor determining unit 105 terminates the notification processing.

In step S101, if there is no FE in the workpiece (S101:NO), the sensor determining unit 105 determines whether the heater temperature is smaller than the first sensor threshold value (S108).

As described above, according to the notification processing, an abnormality of a workpiece determined based on the first defect threshold value and a warning about a workpiece determined based on the second defect threshold value are notified, and an abnormality of the measured object determined based on the first sensor threshold value and a warning about the measured object determined based on the second sensor threshold value are notified. Both of the notifications regarding the workpiece and the measured object are determined based on the threshold values different from the set threshold value, and the maintainer can thereby recognize a possibility of an abnormality beforehand. Further, a defect type and a sensor type presumably having high correlativity are associated with each other, and when these defect type and sensor type satisfy a determining criterion of the second defect threshold value and a determining criterion of the second sensor threshold value, it is estimated that an abnormality is generated in a workpiece and a measured object. Such estimation is notified to the maintainer, and thus the maintainer can recognize the abnormality in the workpiece and the measured object before the number or the size of defects reach the first defect threshold value or before the measured value by the sensor exceeds a range defined by the first sensor threshold value.

In the embodiments, the manufacturing line monitoring program is described as being previously installed in the server serving as the manufacturing line monitoring device, although the manufacturing line monitoring program in the embodiments includes a program stored in a storage medium. In this regard, the storage medium includes any medium readable and executable by a computer as the server, such as a medium that can be connected and disconnected to the server and a medium that can be transmitted via a network, including a magnetic tape, a magnetic disc (e.g., hard disk drive), an optical disc (e.g., CD-ROM, DVD disc), a magneto-optical disc (e.g., MO), and a flash memory.

While certain embodiments have been described, these embodiments have been presented by way of example only, and are not intended to limit the scope of the inventions. Indeed, the novel embodiments described herein may be embodied in a variety of other forms. Furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A manufacturing line monitoring device connected to a client terminal via a network, comprising:
a receiving unit that receives sensor data indicative of a measured value by a sensor provided near a manufacturing device constituting a manufacturing line;
a sensor determining unit that determines whether the measured value indicated by the sensor data exceeds a first sensor threshold value indicative of a predetermined range; and
a notifying unit that sends a sensor abnormality notification, which notifies a user of the client terminal that the manufacturing device malfunctions, in a case where the sensor determining unit determines that the measured value exceeds the first sensor threshold value.

2. The manufacturing line monitoring device according to claim 1, wherein
the sensor determining unit further determines whether the measured value exceeds a second sensor threshold value that is different from the first sensor threshold value by a predetermined amount within the range, and
in a case where the sensor determining unit determines that the measured value exceeds the second sensor threshold value, the notifying unit sends a sensor warning notification to the client terminal to notify the user of a possibility that the manufacturing device will malfunction.

3. The manufacturing line monitoring device according to claim 1, wherein
the receiving unit receives defect data, which is output by an inspection equipment and indicates a defect type and the number of defects represented by the defect type, the inspection equipment inspecting a defect on a workpiece manufactured in the manufacturing line,
the manufacturing line monitoring device further comprises a defect determining unit that determines whether the number of defects indicated by the defect data is greater than a predetermined first defect threshold value, and
in a case where the defect determining unit determines that the number of defects is greater than the first defect threshold value, the notifying unit sends a defect abnormality notification to the client terminal to inform the user that the workpiece is a defective.

4. The manufacturing line monitoring device according to claim 3, wherein
the defect determining unit further determines whether the number of defects is greater than a second defect threshold value that is smaller than the first defect threshold value by a predetermined amount, and
in a case where the defect determining unit determines that the number of defects is greater than the second defect threshold value, the notifying unit sends a defect warning notification to the client terminal to inform the user of a possibility that the workpiece is a defective.

5. The manufacturing line monitoring device according to claim 4, further comprising a setting unit that associates a predetermined defect type indicated by the defect data with a predetermined sensor indicated by the sensor data based on an indication by the client terminal, wherein
in a case where the defect determining unit determines that the number of defects indicated by the predetermined defect type is greater than the second defect threshold value and the sensor determining unit determines that a measured value by the sensor, which is associated with the predetermined defect type by the setting unit, exceeds the second sensor threshold value, the notifying unit sends the defect abnormality notification and the sensor abnormality notification to the client terminal.

6. A manufacturing line monitoring program executed by a computer connected to a client device via a network, the program causing the computer to execute:
receiving sensor data indicative of a measured value by a sensor provided near a manufacturing device constituting a manufacturing line;
determining whether the measured value indicated by the sensor data exceeds a first sensor threshold value indicative of a predetermined range; and
sending a sensor abnormality notification, which notifies a user of the client terminal that the manufacturing device malfunctions, in a case where it is determined that the measured value exceeds the first sensor threshold value.

7. A manufacturing line monitoring method executed by a computer connected to a client device via a network, comprising:
receiving sensor data indicative of a measured value by a sensor provided near a manufacturing device constituting a manufacturing line;
determining whether the measured value indicated by the sensor data exceeds a first sensor threshold value indicative of a predetermined range; and
sending a sensor abnormality notification, which notifies a user of the client terminal that the manufacturing device malfunctions, in a case where it is determined that the measured value exceeds the first sensor threshold value.

8. The manufacturing line monitoring device according to claim 2, wherein
the receiving unit receives defect data, which is output by an inspection equipment and indicates a defect type and the number of defects represented by the defect type, the inspection equipment inspecting a defect on a workpiece manufactured in the manufacturing line,
the manufacturing line monitoring device further comprises a defect determining unit that determines whether the number of defects indicated by the defect data is greater than a predetermined first defect threshold value, and
in a case where the defect determining unit determines that the number of defects is greater than the first defect threshold value, the notifying unit sends a defect abnormality notification to the client terminal to inform the user that the workpiece is a defective.

9. The manufacturing line monitoring device according to claim 8, wherein
the defect determining unit further determines whether the number of defects is greater than a second defect threshold value that is smaller than the first defect threshold value by a predetermined amount, and
in a case where the defect determining unit determines that the number of defects is greater than the second defect threshold value, the notifying unit sends a defect warning notification to the client terminal to inform the user of a possibility that the workpiece is a defective.

10. The manufacturing line monitoring device according to claim 9, further comprising a setting unit that associates a predetermined defect type indicated by the defect data with a predetermined sensor indicated by the sensor data based on an indication by the client terminal, wherein
in a case where the defect determining unit determines that the number of defects indicated by the predetermined defect type is greater than the second defect threshold value and the sensor determining unit determines that a measured value by the sensor, which is associated with the predetermined defect type by the setting unit, exceeds the second sensor threshold value, the notifying unit sends the defect abnormality notification and the sensor abnormality notification to the client terminal.

11. A manufacturing line monitoring device connected to a client terminal via a network, comprising:
a receiving unit that receives sensor data and defect data, the sensor data indicating a measured value by a sensor provided near a manufacturing device constituting a manufacturing line, the defect data being output by a inspection equipment and indicating a defect type and the number of defects represented by the defect type, the inspection equipment inspecting a defect on a workpiece manufactured in the manufacturing line;
a sensor determining unit that determines whether the measured value indicated by the sensor data exceeds a first sensor threshold value indicative of a predetermined range and whether the measured value exceeds a second sensor threshold value that is different from the first sensor threshold value by a predetermined amount within the range;
a defect determining unit that determines whether the number of defects indicated by the defect data is greater than a predetermined first defect threshold value and whether the number of defects is greater than a second defect threshold value that is smaller than the first defect threshold value by a predetermined amount;
a setting unit that associates a predetermined defect type indicated by the defect data with a predetermined sensor indicated by the sensor data based on an indication by the client terminal; and
a notifying unit that sends a defect abnormality notification and a sensor abnormality notification to the client terminal in a case where the defect determining unit determines that the number of defects indicated by the predetermined defect type is greater than the second defect threshold value and the sensor determining unit determines that a measured value by the sensor, which is associated with the predetermined defect type by the setting unit, exceeds the second sensor threshold value, the defect abnormality notification informing a user of the client terminal that the workpiece is a defective, the sensor abnormality notification notifying the user that the manufacturing device malfunctions.

12. The manufacturing line monitoring device according to claim 8, wherein
the notifying unit sends the sensor abnormality notification to the client terminal in a case where the sensor determining unit determines that the measured value exceeds the first sensor threshold value, and sends the defect abnormality notification to the client terminal in a case where the defect determining unit determines that the number of defects is greater than the first defect threshold value.

13. A manufacturing line monitoring program executed by a computer connected to a client device via a network, the program causing the computer to execute:
receiving sensor data indicative of a measured value by a sensor provided near a manufacturing device constituting a manufacturing line and defect data that is output by a inspection equipment, which inspects a defect on a workpiece manufactured in the manufacturing line, and indicates a defect type and the number of defects represented by the defect type;
determining whether the measured value indicated by the sensor data exceeds a first sensor threshold value indicative of a predetermined range and whether the measured value exceeds a second sensor threshold value that is different from the first sensor threshold value by a predetermined amount within the range;
determining whether the number of defects indicated by the defect data is greater than a predetermined first defect threshold value and whether the number of defects is greater than a second defect threshold value that is smaller than the first defect threshold value by a predetermined amount;
associating a predetermined defect type indicated by the defect data with a predetermined sensor indicated by the sensor data based on an indication by the client terminal; and
sending a defect abnormality notification and a sensor abnormality notification to the client terminal in a case where it is determined that the number of defects indicated by the predetermined defect type is greater than the second defect threshold value and that a measured value by the sensor, which is associated with the predetermined defect type, exceeds the second sensor threshold value, the defect abnormality notification informing a user of the client terminal that the workpiece is a defective, the sensor abnormality notification notifying the user that the manufacturing device malfunctions.

14. A manufacturing line monitoring method executed by a computer connected to a client device via a network, comprising:
receiving sensor data indicative of a measured value by a sensor provided near a manufacturing device constituting a manufacturing line and defect data that is output by a inspection equipment, which inspects a defect on a workpiece manufactured in the manufacturing line, and indicates a defect type and the number of defects represented by the defect type;
determining whether the measured value indicated by the sensor data exceeds a first sensor threshold value indicative of a predetermined range and whether the measured value exceeds a second sensor threshold value that is different from the first sensor threshold value by a predetermined amount within the range;
determining whether the number of defects indicated by the defect data is greater than a predetermined first defect threshold value and whether the number of defects is greater than a second defect threshold value that is smaller than the first defect threshold value by a predetermined amount;
associating a predetermined defect type indicated by the defect data with a predetermined sensor indicated by the sensor data based on an indication by the client terminal; and
sending a defect abnormality notification and a sensor abnormality notification to the client terminal in a case where it is determined that the number of defects indicated by the predetermined defect type is greater than the second defect threshold value and that a measured value by the sensor, which is associated with the predetermined defect type, exceeds the second sensor threshold value, the defect abnormality notification informing a user of the client terminal that the workpiece is a defective, the sensor abnormality notification notifying the user that the manufacturing device malfunctions.
